(19) United States
(12) Patent Application Publication
(10) Pub. No.: US 2021/0377294 A1
(43) Pub. Date: Dec. 2, 2021

(54) CONSTRAINING RESOURCE ALLOCATION RATE FOR STATEFUL MULTI-TENANT HTTP PROXIES AND DENIAL-OF-SERVICE ATTACK PREVENTION

(71) Applicant: Citrix Systems, Inc., Fort Lauderdale, FL (US)

(72) Inventors: Punit Gupta, Sunnyvale, CA (US); Sandilya Sangabathula, Santa Clara, CA (US); Kenneth Bell, Sunnyvale, CA (US)

(73) Assignee: Citrix Systems, Inc., Fort Lauderdale, FL (US)

(21) Appl. No.: 17/063,230

(22) Filed: Oct. 5, 2020

Related U.S. Application Data
(60) Provisional application No. 63/031,134, filed on May 28, 2020.

(51) Int. Cl. H04L 29/06; H04L 12/26

(52) U.S. Cl. CPC H04L 63/1458; H04L 63/1425; H04L 67/42; H04L 63/0281; H04L 43/16; H04L 63/1416

(57) ABSTRACT

Implementations of the systems and methods discussed herein provide for distributed HTTP proxy services with synchronization of per-server or per-tenant resource allocation counters amongst the proxy devices, allowing devices to quickly identify denial of service attacks or other malicious or erroneous behavior. In some implementations, a database server may receive resource consumption notifications from each of a plurality of proxy devices and may aggregate the notifications or increment a counter on a per-server or per-tenant basis, and provide updated counter values to proxy devices via callbacks. Each proxy device may check the counter value before utilizing resources, and may disable or block proxy processing responsive to the counter exceeding a threshold.

### RELATED APPLICATION

The present application claims the benefit of priority under 35 U.S.C. § 119(e) to U.S. Provisional Application 63/031,134, filed on May 28, 2020, titled “CONSTRAINING RESOURCE ALLOCATION RATE FOR STATEFUL MULTI-TENANT HTTP PROXIES AND DENIAL-OF-SERVICE ATTACK PREVENTION,” which is incorporated herein by reference in its entirety.

### FIELD OF THE DISCLOSURE

The present application generally relates to network communications and cybersecurity, including but not limited to systems and methods for multi-tenant proxies.

### BACKGROUND

Proxy devices that provide access to resources via rewriting of hypertext transfer protocol (HTTP) links may be vulnerable to malicious attacks, such as denial-of-service (DoS) attacks. For example, a malicious or hacked web server under control of a malicious actor may create a resource with a large number of links, requiring a device performing rewriting proxy services to consume additional processing and memory resources. Additionally, with distributed proxy devices, this malicious behavior may be more difficult to identify early, because the additional resource consumption may be distributed amongst a plurality of devices, hiding the large amount of resources utilized in total.

### SUMMARY

This Summary is provided to introduce a selection of concepts in a simplified form that are further described below in the Detailed Description. This Summary is not intended to identify key features or essential features, nor is it intended to limit the scope of the claims included herewith.

Implementations of the systems and methods discussed herein provide for distributed HTTP proxy services with synchronization of per-server or per-tenant resource allocation counters amongst the proxy devices, allowing devices to quickly identify denial of service attacks or other malicious or erroneous behavior. In some implementations, a database server may receive resource consumption notifications from each of a plurality of proxy devices and may aggregate the notifications or increment a counter on a per-server or per-tenant basis, and provide updated counter values to proxy devices via callbacks. Each proxy device may check the counter value before utilizing resources, and may disable or block proxy processing responsive to the counter exceeding a threshold.

In at least one aspect, a method is provided. The method can include receiving, by a device from a client, a request to access a resource of a server. The device can be intermediary to a plurality of clients and a plurality of servers to proxy access to resources of the plurality of servers for the plurality of clients. The method can include determining, by the device, if a value of a counter of the device is less than a threshold. The threshold can indicate a resource allocation limit. The method can include modifying, by the device responsive to the value of the counter of the device being less than the threshold, one or more links of the resource. The method can include providing, by the device, the resource including the modified one or more links to the client.

In embodiments, the method can include processing, by the device, the resource in multiple portions. Each portion can have a determined size and include at least one link of the one or more links. The method can include providing, by the device to the client device, access to the resource and the modified one or more links through the multiple portions having the determined size. The method can include transmitting, by the device to a database server, a command to generate an entry at the database server for the one or more links of the resource responsive to the value of the counter of the device being less than the threshold. The method can include modifying, by the device, the one or more links of the resource to include a hash value that identifies an association between the respective link and the corresponding modified link and directs subsequent requests from the client via the modified link to the device.

The method can include transmitting, by the device to a database server, a command to increment a value of a counter of the database server for each link of the one or more links associated with the resource. The method can include receiving, by the device from a database server, a value of a counter of the database server indicating a number of resources allocated by a plurality of devices connected to the database server to the plurality of clients. The method can include updating, by the device, the counter of the device to synchronize to the value of the counter of the database server. The method can include receiving, by the device from the client, a request to access one or more resources of the server. The method can include determining, by the device, that the value of the counter of the device is greater than the threshold. The method can include preventing, by the device, the client from accessing the one or more resources of the server.

The method can include transmitting, by the device to a database server responsive to the value of the counter of the device being greater than the threshold, a command to determine if an entry exists at the database server for at least one link of the one or more links of the resource. The method can include modifying, by the device, the at least one link responsive to the entry existing at the database server for the at least one link of the resource. The method can include transmitting, by the device to a database server responsive to the value of the counter of the device being greater than the threshold, a command to determine if an entry exists at the database server for at least one link of the one or more links of the resource. The method can include preventing, by the device, access to the resource for the client responsive to determining the database server does not include the entry for the at least one link of the resource. The method can include receiving, by the device from the client, a request to access a subsequent resource of the server. The subsequent resource including at least one link. The method can include determining, by the device, that the value of the counter of the device is greater than the threshold. The method can include determining, by the device, that the at least one link of the subsequent resource corresponds to previously modified link. The method can include transmitting, by the device to a database server, a command to extend an expiration value for an entry at the database server corresponding to the at least one link.

In at least one aspect, a method is provided. The method can include receiving, by a device from a client, a request to access a resource of a server. The device can be intermediary to a plurality of clients and a plurality of servers to proxy access to resources of the plurality of servers for the plurality of clients. The method can include transmitting, by the device to a database server, a command to create an entry in a database of the database server for the one or more links of the resource. The method can include modifying, by the device, one or more links of the resource. The method can include determining, by the device, whether to provide the modified one or more links of the resource to the client based on a response from the database server indicating if the entry is created for the one or more links of the resource.

In embodiments, the method can include providing, by the device to the client, the modified one or more links of the resource based on the response from the database server indicating that the entry is created for the one or more links of the resource. The method can include transmitting, by the device to a database server, a command to increment a value of a counter of the database server for each link of the one or more links associated with the resource. The method can include preventing, by the device, the client from accessing the resource based on the response from the database server indicating that the entry is not created for the one or more links of the resource. The method can include determining, by the device, that a value of a counter of the device is less than a threshold, the threshold indicative of a resource allocation limit for the device. The method can include providing, by the device, the resource including the modified links to the client.

The method can include determining, by the device, that a value of a counter of the device is greater than a threshold, the threshold indicative of a resource allocation limit for the device. The method can include determining, by the device, that the one or more links of the resource correspond to previously modified links. The method can include transmitting, by the device to a database server, a command to extend an expiration value for entries at the database server corresponding to the one or more links. The method can include determining, by the device, that a value of a counter of the device is greater than a threshold. The threshold can indicate of a resource allocation limit for the device. The method can include determining, by the device, that the one or more links of the resource correspond to new requests. The method can include preventing, by the device, access to the resource for the client.

In at least one aspect, a device is provided. The device can include one or more processors coupled to memory. The device can be configured to receive, from a client, a request to access a resource of a server. The device can be intermediary to a plurality of clients and a plurality of servers to proxy access to resources of the plurality of servers for the plurality of clients. The device can be configured to determine if a value of a counter of the device is less than a threshold, the threshold indicative of a resource allocation limit. The device can be configured to modify, responsive to the value of the counter of the device being less than the threshold, one or more links of the resource. The device can be configured to provide the resource including the modified one or more links to the client.

The device can be configured to receive, from a database server, a value of a counter of the database server indicating a number of resources allocated by a plurality of devices connected to the database server. The device can be configured to update the counter of the device to synchronize to the value of the counter of the database server. The device can be configured to transmit, to a database server responsive to the value of the counter of the device is greater than the threshold, a command to determine if an entry exists at the database server for at least one link of the one or more links of the resource. The device can be configured to modify the at least one link responsive to the entry existing at the database server for the at least one link of the resource.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5A is a block diagram of an example implementation of an HTTP proxy service;

FIG. 5B is a block diagram of an example implementation of a distributed HTTP proxy service;

FIG. 5C is a block diagram of an implementation of distributed HTTP proxy gateways and a proxy database server; and

FIGS. 6A-6D are flow diagrams of implementations of a method for synchronization and constraint of resource allocation rates for stateful multi-tenant HTTP proxies.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for virtualizing an application delivery controller;

Section D describes embodiments of systems and methods for providing a clustered appliance architecture environment; and

Section E describes systems and methods for constraining resource allocation rates for stateful multi-tenant HTTP proxies and denial-of-service attack prevention.

### A. Network and Computing Environment

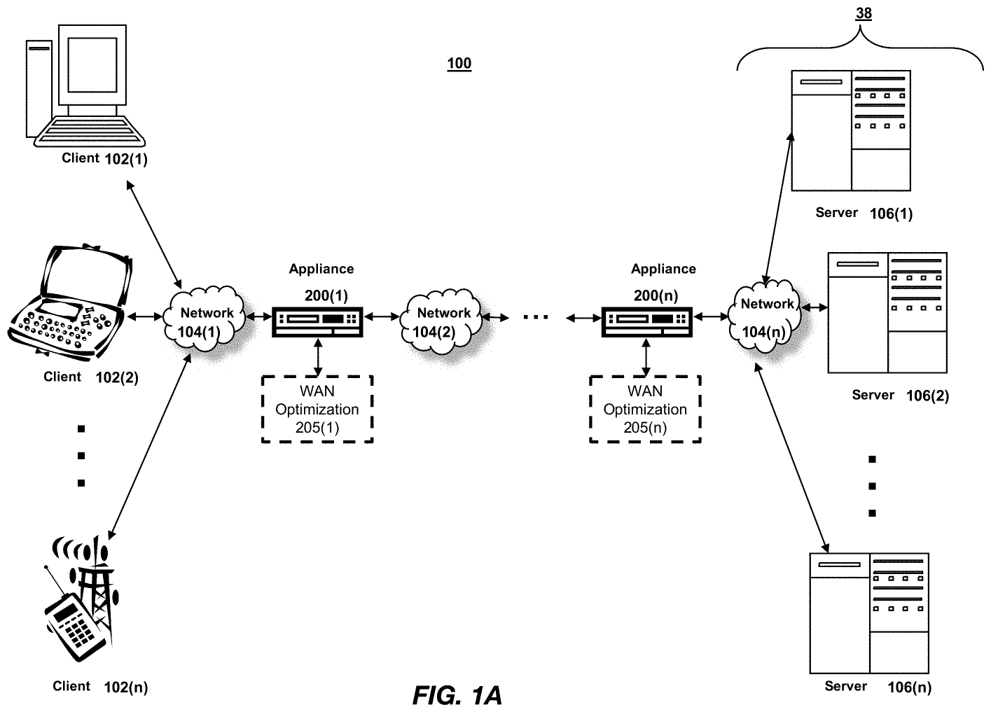

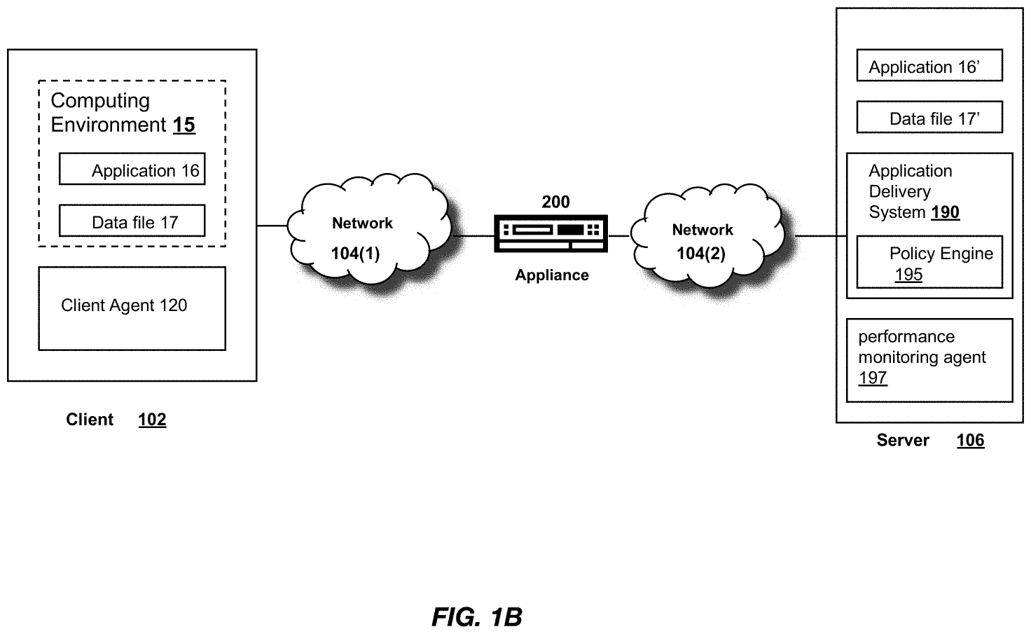

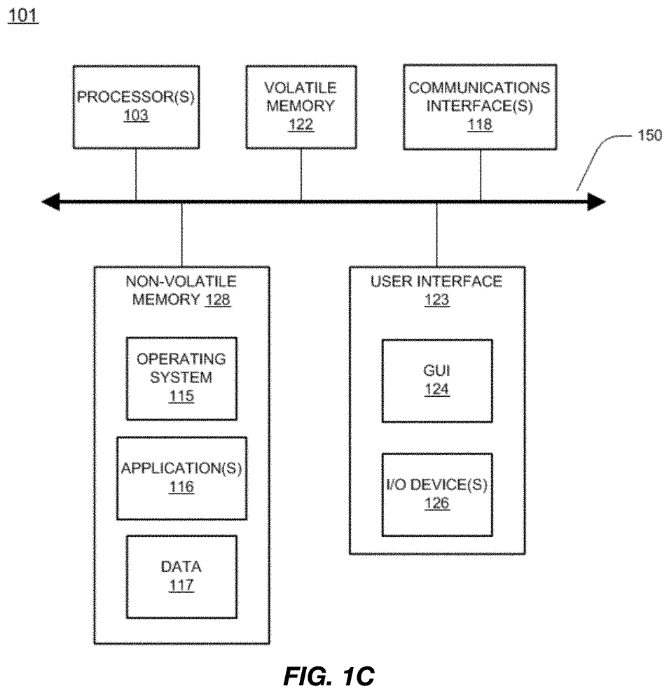

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, Fla.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, Fla.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, Fla. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, Fla.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

Additional details of the implementation and operation of network environment 100, clients 102, servers 106, and appliances 200 and 205 may be as described in U.S. Pat. No. 9,538,345, issued Jan. 3, 2017 to Citrix Systems, Inc. of Fort Lauderdale, Fla., the teachings of which are hereby incorporated herein by reference.

### B. Appliance Architecture

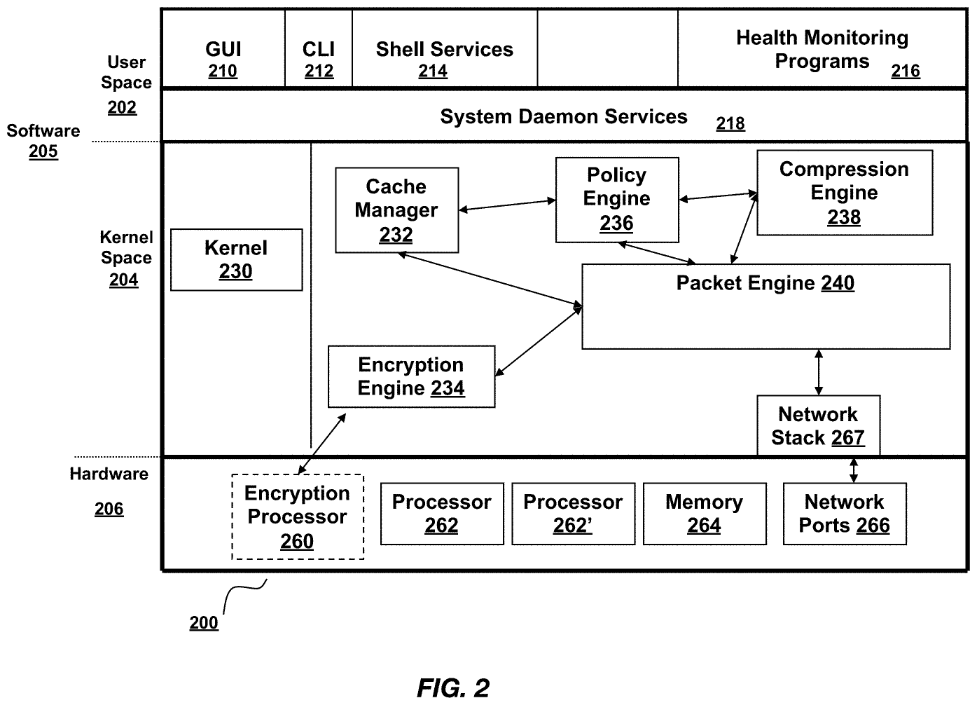

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of appliance 200. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, Fla. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

Additional details of the implementation and operation of appliance 200 may be as described in U.S. Pat. No. 9,538,345, issued Jan. 3, 2017 to Citrix Systems, Inc. of Fort Lauderdale, Fla., the teachings of which are hereby incorporated herein by reference.

### C. Systems and Methods for Providing Virtualized Application Delivery Controller

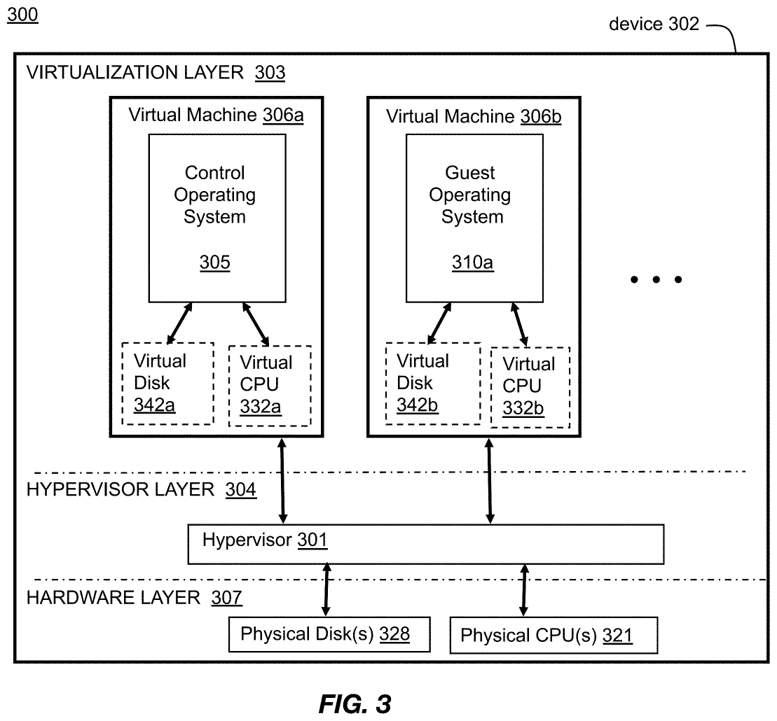

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, Fla. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

Additional details of the implementation and operation of virtualized computing environment 300 may be as described in U.S. Pat. No. 9,538,345, issued Jan. 3, 2017 to Citrix Systems, Inc. of Fort Lauderdale, Fla., the teachings of which are hereby incorporated herein by reference.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

Additional details of the implementation and operation of a multi-processor and/or multi-core system may be as described in U.S. Pat. No. 9,538,345, issued Jan. 3, 2017 to Citrix Systems, Inc. of Fort Lauderdale, Fla., the teachings of which are hereby incorporated herein by reference.

### D. Systems and Methods for Providing a Distributed Cluster Architecture

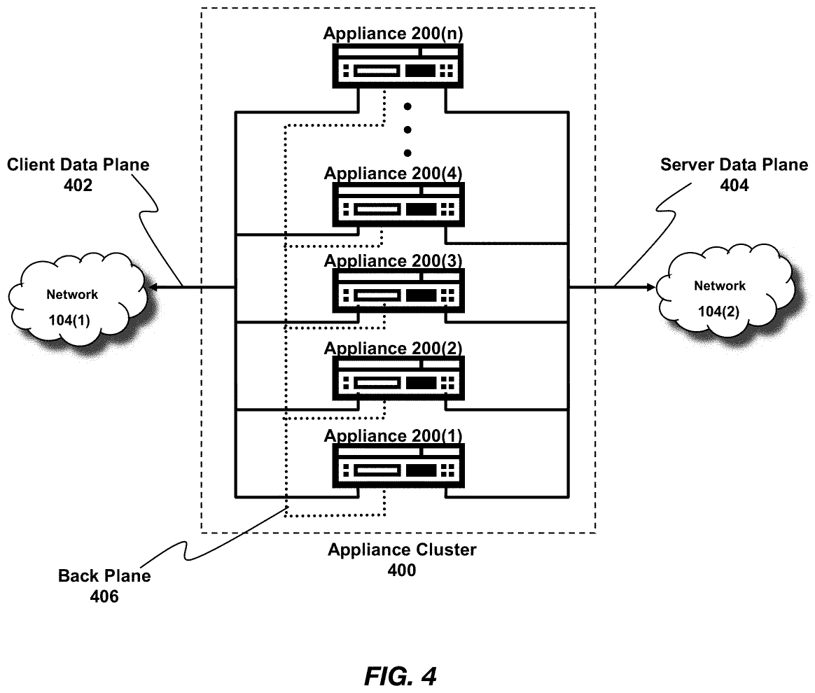

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a first network 104(1) via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104(2) via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

Additional details of cluster 400 may be as described in U.S. Pat. No. 9,538,345, issued Jan. 3, 2017 to Citrix Systems, Inc. of Fort Lauderdale, Fla., the teachings of which are hereby incorporated herein by reference.

### E. Systems and Methods for Constraining Resource Allocation Rates for Stateful Multi-Tenant HTTP Proxies and Denial-of-Service Attack Prevention

Hypertext transfer protocol (HTTP) proxies may be used to provide secure remote access to corporate web servers or other network resources to client devices in a lightweight manner without requiring the use of a virtual private network (VPN) or other such security protocols that may be complicated or difficult for end users to configure, or may require the use of additional resources. For example, the Gateway Service and Access Control Services provided by Citrix Systems, Inc. allow remote access to resources using a lightweight client such as a web browser or client application without requiring establishment or configuration of a VPN. Implementations of such proxy devices may dynamically rewrite links present in web pages of a corporate server or other network resource while those pages are being served, providing proxied access to the pages.

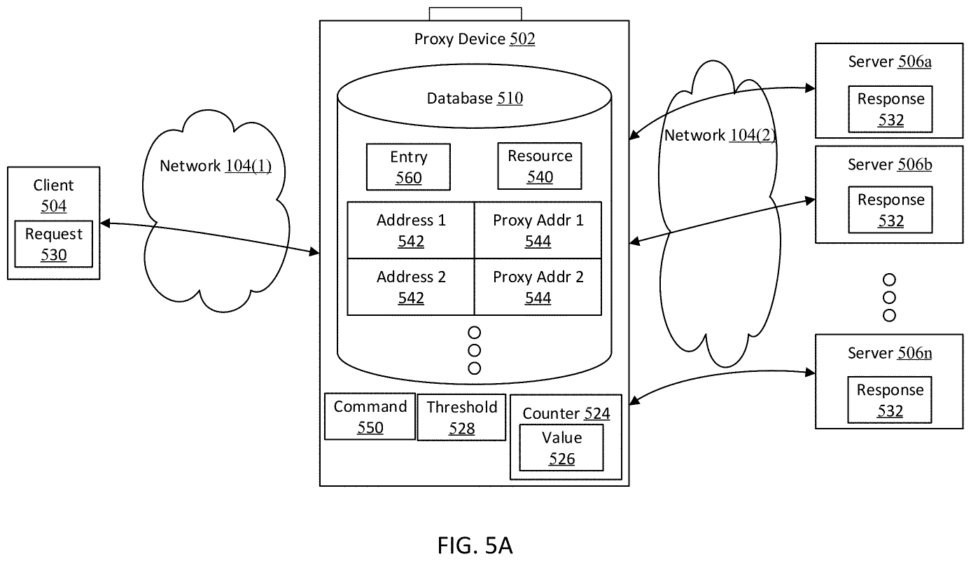

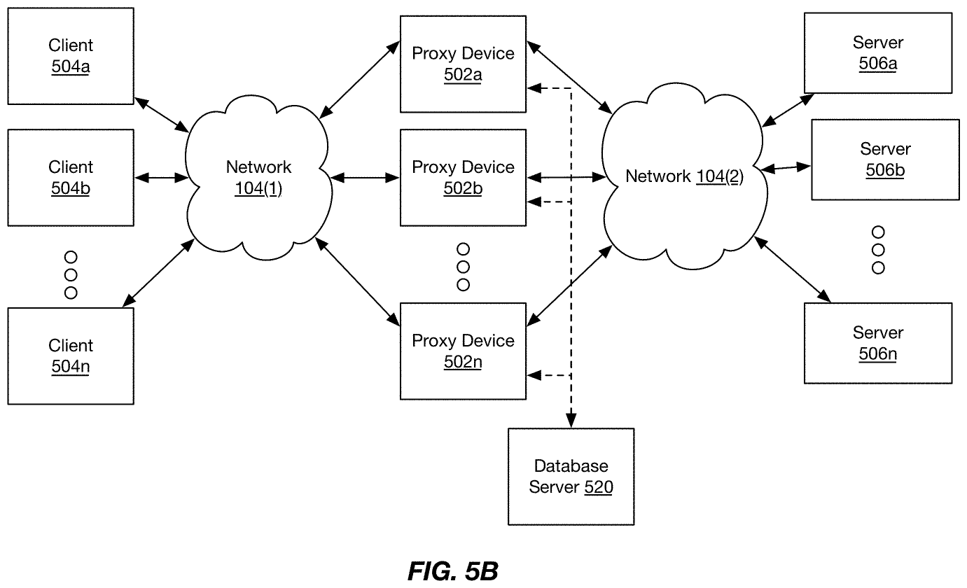

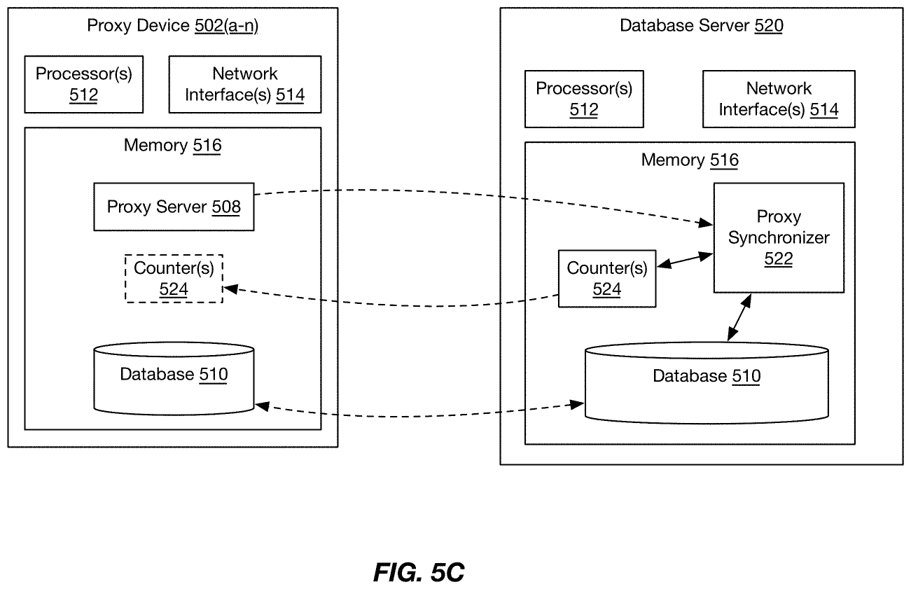

For example, FIG. 5A is a block diagram of an example implementation of an HTTP proxy service 502. Proxy gateway 502, sometimes referred to as a proxy device, a proxy server, an HTTP proxy, or by similar terms, may be deployed as an intermediary between one or more client devices 504 (or other such devices, not illustrated) and one or more servers 506a-506n, referred to generally as server(s) 506 (or other such devices, not illustrated). For example, in many implementations, a proxy gateway 502 may be deployed as an intermediary between a first server 506 and a second server 506. Although shown as an intermediary between two networks 104(1) and 104(2), in many implementations, a proxy gateway 502 may be connected to a common network 104 with client devices 504 and server 506, and may serve as a logical intermediary for communications (e.g. proxied communications flows between clients and servers may traverse the proxy device or be redirected by the proxy device to endpoints). Proxy gateway 502 may comprise a server, appliance, cluster of appliances, virtual computing device provided by one or more physical computing devices, or any other type and form of computing device. In many implementations, a proxy gateway 502 may be configured as part of another network device, such as a firewall, gateway, switch, network accelerator, or other such device.

To provide proxied communications between client devices and servers, a proxy device 502 may receive a request to access a web page or other network resource from a client device. The proxy device 502 may retrieve a copy of the requested web page or other network resource, and may identify and rewrite or modify HTTP links to further web pages or network resources within the requested web page or network resource. For example, having retrieved a first web page including an HTTP link to a second web page at a specified uniform resource locator (URL) address within the corporate network or other protected environment, such as “webserver.customer.net”, the proxy device may modify or rewrite the link to replace the URL with a proxied URL such as “hashvalue.gateway.cloud.com” that is hosted by the proxy device or proxy service. The hashvalue may comprise a unique or semi-unique code generated by the proxy device, and may serve as a key for a database entry (e.g. stored within database 510 of the proxy gateway 502) that identifies the association between the original non-rewritten or unmodified URL and the rewritten proxy URL. The modified web page may be provided to the client device, and further requests by the client may be directed to the proxied URLs provided by the proxy device, thus allowing the proxy device to serve as an intermediary for communications between the client and server and provide additional access controls, security, encryption or compression services, etc.

Proxy devices that provide access to resources via rewriting of HTTP links may be vulnerable to malicious attacks, such as denial-of-service (DoS) attacks, due to the number of database entries that may be created when accessing a web page. For example, a malicious or hacked web server under control of a malicious actor may create a resource with a large number of links (e.g. tens of thousands or even millions of links within a single web page), requiring a proxy device performing rewriting proxy services to generate hash values and create a corresponding large number of database entries, consuming additional processing and memory resources. This may exhaust memory, storage, or database capacity at the proxy device in a short span of time, preventing the proxy device from providing service to legitimate clients. Furthermore, some proxy devices provide proxy services to large numbers of corporate enterprises or servers of multiple organizations, sometimes referred to as tenants. These multi-tenant proxy devices may be similarly vulnerable to such DoS attacks, but worse, because one malicious actor or web page from one tenant may render the proxy device unable to provide service to any tenant, causing outages for many enterprises or organizations simultaneously.

Additionally, although shown as a single device in FIG. 5A, in many implementations, multiple proxy devices 502 may be utilized for load balancing or distribution, to provide scalability and service for larger numbers of clients and servers. FIG. 5B is a block diagram of an example implementation of a distributed HTTP proxy service in which multiple proxy devices 502a-502n (referred to generally as proxy devices 502) are deployed as a group or cluster, sometimes referred to as a distributed multi-node service, to provide service to large numbers of clients and servers. In many implementations, proxy devices 502 may be virtual devices executed by one or more physical devices (e.g. as a cloud service). Each proxy device 502 may perform as described above in connection with FIG. 5A, providing proxy services for different client devices. In many implementations, proxy devices 502 may provide proxy services for the same server 506 with multiple client devices. For example, a first client device 504a may communicate with a first server 506a via a first proxy device 502a, while a second client device 504b may communicate with the first server 506a via a second proxy device 502b.

However, these distributed proxy services may make it more difficult to identify malicious behavior by a server or other bad actor. For example, if a proxy device is configured with a security policy to prevent rewriting of links in a web page comprising a million links, a malicious actor may be able to circumvent the policy by providing web pages with a mere five-hundred thousand links—and then serving the page via a large plurality of proxy devices 502, such that while each device only creates half a million database entries, a dozen proxy devices may create six million database entries between them. Synchronizing these databases may quickly become near impossible. Accordingly, the additional resource consumption from such attacks may be distributed amongst a plurality of devices, hiding the large amount of resources utilized in total.

Implementations of the systems and methods discussed herein provide for distributed HTTP proxy services with synchronization of per-server or per-tenant resource allocation counters amongst the proxy devices, allowing devices to quickly identify denial of service attacks or other malicious or erroneous behavior while ensuring that end-user experience and the performance of the proxy device and the systems it serves are not adversely impacted. In some implementations, a database server 520 may receive resource consumption notifications from each of a plurality of proxy devices 502 and may aggregate the notifications or increment a counter on a per-server or per-tenant basis, and provide updated counter values to proxy devices via callbacks. Each proxy device may check the counter value before utilizing resources, and may disable or block proxy processing responsive to the counter exceeding a threshold. By setting this threshold above what is likely to be reached by non-malicious or genuine tenants or servers, denial of service attacks or malicious behavior may be constrained and throttled without adversely affecting normal services.

In some implementations, allocation of a resource or providing proxy services for a page or resource, including generating database entries, only results in an actual reduction in a proxy device's capacity if it was a new resource that did not already exist. For example, if a database entry has already been generated for a particular link or entries have already been generated for a particular page or resource, then providing further proxy services for that page or link may not require generating further entries. By tracking whether providing proxy services for a page or resource requires new entries or uses existing entries, the proxy device may continue providing services for even servers or tenants who have exceeded the per-server or per-tenant threshold (e.g. continue providing proxy services for legitimate pages on a server while blocking or rate-limiting access to illegitimate or malicious pages on the same server responsive to the counter for that server exceeding the threshold).

In some such implementations, the proxy device may not know whether the resource or database entry already exists until it makes a call to the database server to check for its existence. However, transmitting a request for verification of each entry may require significant communication between the proxy device and database server, adversely affecting performance. Without such communications, the proxy device may know that threshold has exceeded, but does not know whether the web page or resource being accessed is a new resource that should be constrained, or an existing resource that should not be constrained.

In a similar situation, a proxy device may not yet know if the threshold has exceeded (e.g. prior to receiving a counter value from the database server) but may need to process the resource in order to provide low latency access to client devices (e.g. for streaming data, for example). The proxy device can make a call to the database server before processing each link or adding a database entry in order to check if the counter has yet exceeded the threshold, but this may similarly require significant communication between the proxy device and database server and adversely affect the performance of the system and the end-user experience.

To address both of these situations, in some implementations, the proxy device may continue processing links and providing proxy services regardless of whether the counter value for the server or tenant has been exceeded (e.g. allowing slight overshoot of the threshold, resulting in a trade-off of accurate enforcement for ‘good enough’ enforcement in exchange for reduced communications and bandwidth consumption and greater performance for client devices). In some implementations, responsive to the counter exceeding a threshold, the proxy device may disable or block proxy processing only for new resources, and not for existing resources (e.g. disabling proxy-processing if it is a completely new link to be rewritten, but not if it is a link that was seen in the past and an entry or mapping in the database already exists for it).

FIG. 5C is a block diagram of an implementation of distributed HTTP proxy devices 502 and a proxy database server 520. As discussed above, HTTP proxy devices 502 may comprise any type and form of computing device or network device, including clusters, clouds, or farms of computing devices. In some implementations, proxy devices 502 may be referred to as proxy instances, such as when proxy devices 502 comprise virtual computing devices. Proxy devices 502 may include appliances 200, optimization devices 205, appliance clusters 400, or any other type and form of device discussed herein, and may comprise one or more processors 512, one or more network interfaces 514, and one or more memory devices 516, as well as other components not illustrated (e.g. input/output devices, operating systems, etc.). Processors 512 may comprise any type and form of processor or co-processor, including FPGAs, ASICs, or other processors as discussed above. Similarly, network interfaces 514 may comprise any type and form of network interfaces, including 100BaseT, 1000BaseT, 10 GbE, or any other type of Ethernet connection, cable broadband interfaces, cellular interfaces, satellite interfaces, fiber interfaces, or any other interface or combination of interfaces. Similarly, memory 516 may comprise nonvolatile memory, volatile memory, flash memory, hard drives, or any other type and form of internal or external memory device.

A proxy device 502 may execute a proxy server 508 for providing proxied connections to one or more network resources, such as enterprise or corporate servers or other resources. Proxy server 508 may comprise an application, service, server, daemon, routine, or other executable logic for requesting web pages or other resources, generating proxy URLs and rewriting links within web pages or other resources, and serving proxied pages or resources to client devices. Proxy server 508 may be implemented in hardware, such as ASICs or FPGAs in some implementations. In some implementations, proxy server 508 may allocate resources to different connections, clients, servers, or tenants, based on the content of an HTTP transaction under third party control (either client and/or server). As discussed above, in many implementations, communications with a single tenant or even a single server and multiple clients may be processed by multiple proxy devices or instances. Communications via proxy devices may be performance sensitive, and so in many implementations, request streaming and low latencies may be valuable. Preventing DoS attacks is important to providing this high performance, while avoiding over-throttling or limiting legitimate communications.

Database server 520 may comprise another computing device or devices, including one or more virtual computing devices. Database server 520 may include many of the same components as proxy devices 502, such as processors 512, network interfaces 514, and memory 516. In some implementations, database server 520 may comprise a proxy device and may sometimes be referred to as a master proxy device.

Database server 520 may execute a proxy synchronizer 522. Proxy synchronizer 522 may comprise an application, server, service, daemon, routine, or other executable logic for maintaining one or more counters 524 for proxied services, and for providing counter values to proxy devices 502. Counters 524 may be reset or initialized (or in some implementations, archived, logged, or deleted) periodically, such as daily. For example, counters 524 may be time-restricted and associated with proxied services on a per-server or per-tenant (e.g. associated with a group of servers owned or managed by an entity), such as a daily counter per-tenant. In some implementations, each counter may be named with an identifier of a server or tenant and a time period identifier, such as “tenant-name XX”, where XX is the time period such as a day, hour, minute, or other such time measuring period.

Counters 524 may be incremented for each resource allocation by a proxy device (e.g. responsive to creation of a database entry for a proxied service, as discussed above). In order to maintain the synchronization of counters 524, responsive to creation of a database entry (e.g. upon generating a hash value and creating an associated hash value-based proxy URL as discussed above), a proxy device 502 may transmit an increment command to the database server 520. The increment command may comprise an identifier of the corresponding counter (e.g. tenant or server identifier and time period identifier, as discussed above). The database server may increment the corresponding counter (or create the counter, if one has not yet been created or initialized, such as for the first proxied service in a given time period, in some implementations) and may respond to the increment command with a callback identifying the new value of the counter. The proxy device 502 may store the new value of the counter in memory of the proxy device, and may compare this counter value to a threshold when determining whether to provide further proxy services for a tenant or server. In many implementations, such as where multiple database entries are created simultaneously or nearly simultaneously (e.g. when a web page includes a dozen links that are all rewritten or modified by the proxy, and when the proxy accordingly generates a dozen new database entries), the increment commands may be sent asynchronously, such as after creating the entries and providing the web page to the requesting client. This may result in the counter value being slightly delayed or lagging relative to real time, but may reduce latency of serving the page relative to waiting first for commands and callbacks to and from the database server before serving the page. Increment commands may be sent as remote procedure calls, application programming interface (API) calls, representational state transfer (RESTful) requests such as HTTP GET or POST requests with a parameter-value pair, or via any other such protocol. Similarly, responses may comprise API callbacks or returns, HTTP status responses, or any other such protocol.

In many implementations, the counter values maintained by the database server 520 may be provided to proxy devices 502 only in response to increment commands from those specific proxy devices 502, while in other implementations, counter values may be pushed to all proxy devices 502 responsive to receipt of an increment command from one proxy device. This may provide better synchronization between devices, at the expense of additional communications between the devices. However, in many implementations in which different proxy devices provide distributed services for the same servers or tenants, this may be unnecessary, as each proxy device serving a particular server or tenant will likely eventually send an increment command for the server or tenant and receive the updated counter value.

In some implementations, upon creation of a database entry, the database entry may be shared by the proxy device with the database server 520, which may in turn share the database with other proxy devices, allowing synchronization of databases 510 between proxy devices. In other implementations, the database server 520 may maintain a single database 510 and may receive entry generation commands and requests for proxied addresses for rewriting of original addresses from proxy devices 502 and may respectively add entries to the database 510 and respond with entry data from the database 510. In still other implementations, databases 510 may be local to each proxy device 502 and may not be shared.

As discussed above, upon receipt of a web page or other resource from a server for rewriting, the proxy device may compare its local counter 524 value for the server or tenant to a threshold. If the value exceeds the threshold, then the proxy device may constrain or throttle the proxy services for that server or tenant, block or disable proxy services for the server or tenant, report an error or potentially malicious behavior to an administrator or management service, or perform other such functions. As these counters expire periodically, the threshold should not be exceeded during typical or normal operations. Synchronizing the counters according to the systems and methods discussed herein further allows for multiple resource allocations per HTTP transaction (e.g. on a rewritten entry-by-entry basis) and variable sizes of resource allocation (e.g. depending on the number of links to be rewritten in a document); allows for streaming data (e.g. HTTP live streaming or similar protocols) and hitting a rate limit mid-stream; and works asynchronously to avoid latency issues between the proxy and database server and enable low-latency service to client devices for streaming and other purposes.

As an example illustration of this synchronization, assume a per-day per-tenant threshold of N, such that any servers of any given tenant will not be allowed to cause the creation of more than N database entries in a day. The value of N can be manually configured or may be dynamically or heuristically determined and tuned (e.g. max 20000 links per tenant per day across all the web-servers that get accessed by users of that tenant in a day). During initialization, in some implementations, each proxy device may retrieve the threshold value from the database server. In general, the value of N may be chosen to be big enough such that the limit will never get hit by performing regular work-related activities (e.g. it will be hit only if a malicious webserver was trying to do a DoS attack as described above or on other abnormal behavior). Being a distributed multi-node cloud service, each of the nodes of the proxy service need to synchronize the current value of the total count so as to apply the global per-day per-tenant limit regardless of which proxy node services any particular request. Thus, even if a particular node has rewritten only N/100 links during the course of a day (e.g. created only N/100 database entries), it is still possible that the total count across all the nodes has already reached N, and hence, the node should not allow any more database entries.

As discussed above, each per-server or per-tenant counter may be generated or started by the database server 520 upon receipt of a first corresponding increment command from a proxy device during a given time period, and set to a value of 1, and configured to automatically expire at the end of the time period (the expired timer values may be logged or archived for later analysis in some implementations, such as for fine tuning thresholds). Each proxy node may process web pages or other resources, in some implementations in chunks or portions (such as 4 KB chunks). This may be used to prevent the risk of a single malicious page having millions of links, as the page will be processed in stages and the counter value will be quickly incremented. It also ensures that the page is served or streamed with low latency, regardless of the size of the entire response. To accommodate instances in which a link to be rewritten is present across the boundary of two chunks, an additional amount may be accumulated or the chunk may be extended, such that the link is complete within a single chunk (e.g. if a link crosses a border between two 4 KB chunks, the first chunk may be extended by as many bytes as are necessary to include the complete link).

As discussed above, in order to address situations in which the proxy device does not know whether a counter threshold has been exceeded, and/or does not know whether providing proxy services for a resource will require generation of new database entries and consumption of memory, in some implementations, before sending an increment command for to the database server, the proxy device may first send an asynchronous “create if not exists” command to the database server, sometimes referred to as a conditional create command or by similar terms. The conditional create command may comprise a hash value, index value, or key, and an address or value of the original URL to be proxied, similar to the proxied URL and original URL discussed above. By sending the command asynchronously, the proxy device may continue to process the page or resource and rewrite links present in the page or resource without waiting for a response from the server. The conditional create command may be sent via any suitable protocol, such as an API call, a remote procedure call, a RESTful request, etc., as discussed above. In response to the conditional create command, the database server may determine whether a corresponding entry exists or does not exist in its databases, and may respectively send an asynchronous callback to the proxy device indicating whether the command resulted in creation of a new database entry or not. Only if the command resulted in creation of a new database entry or allocation of a new resource does the proxy device then send an increment command to the database server to increment the counter value relative to the threshold, in such implementations.

In some implementations, if the proxy device determines that the threshold has already been exceeded based on the current value of the counter in its memory, then the proxy device should disable rewriting of links only if it is a new link that would result in creation of new database entry (to enforce the threshold limit). If it is an ‘already seen’ link for which a database entry already exists, then the proxy device should continue to rewrite the link as normal. As discussed above, in many implementations, it may not be desirable to block the processing of the current page or chunk just to determine whether each link is a new link or an existing one as it would significantly impact the performance and the end user experience. Accordingly, in some implementations, the proxy device may rewrite the links present on the chunks or pages or resources and stream or transmit those chunks or pages or resources to the client device as discussed above; however, after the threshold for the server or tenant has been exceeded, on each rewrite of a link, the proxy device may send an asynchronous “expire (keyHash, TTL)” command (sometimes referred to as an expiration command or a refresh command) comprising an identification of the hash value or index value or proxied URL along with a time-to-live value to the database server. This may be sent instead of the conditional create command discussed above, in some implementations. The expiration command instructs the database server to expire (archive, delete, remove, etc.) the corresponding database entry (represented by keyHash) after a TTL period. If the database entry is a new entry that does not already exist in the server's database, then the expiration command may result in no operation by the server. Accordingly, the threshold limit is enforced as no new database entry is created if one did not previously exist; however, if the database entry exists, then its expiry time is simply get extended by TTL amount of time (e.g. 1 day, 7 days, 30 days, or any other appropriate value). This may ensure that already existing database entries do not get impacted due to blocking or disabling of proxy services after threshold has been exceeded. Accordingly, after exceeding the threshold, the proxy device will be able to disable or block the proxy-services in an intelligent manner such that this disabling of proxy services impacts only the new links or database entries and not existing links or database entries.

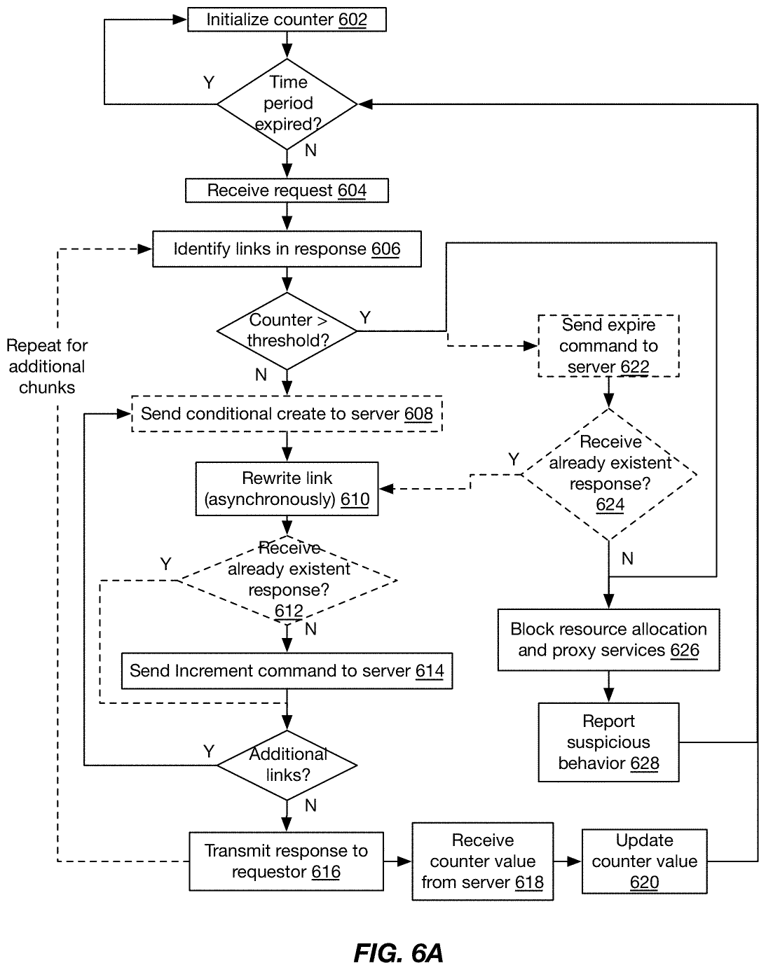

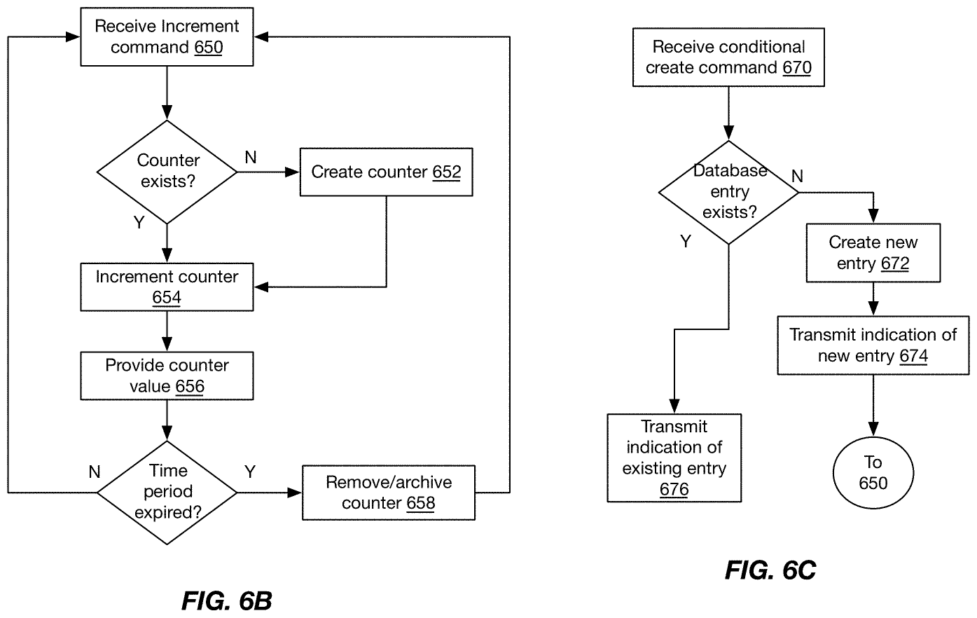

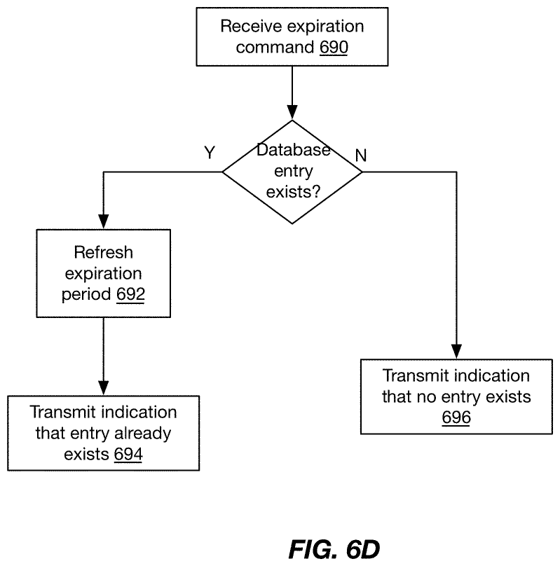

FIGS. 6A and 6B are flow diagrams of implementations of a method for synchronization and constraint of resource allocation rates for stateful multi-tenant HTTP proxies. Referring first to FIG. 6A, at step 602, such as on start up or at the beginning of a time period, a proxy device may initialize or reset any local counter values (or archive the counter values, provide the counter values to a management service, etc.). In some implementations, the proxy device may retrieve a threshold value for a tenant or server (or multiple thresholds for different tenants or servers, in some implementations) from a database server, management server, or other device. The proxy device may then wait for incoming requests to provide access to proxied servers or services.

At step 604, in some implementations, the proxy device 502 (e.g., device 502) may receive a request 530 for access to a server 506 or web page from a client 504, or the proxy device 502 may intercept a request 530 to a server 506 or a response 532 from the server 506 to a client request 530. The proxy device 502 can receiver a request 530 from a client 504 to access a resource 540 (e.g., web page, application) or multiple resources 540 of a server 506. The proxy device 502 may be intermediary to a plurality of clients 504 and a plurality of servers 506 to proxy access to resources 540 of the plurality of servers 506 for the plurality of clients 504. The proxy device 502 may retrieve the page or resource 540 to be served, in chunks in some implementations as discussed above, and at step 606 may identify the number of links 542 in the page or resource 540 or chunk to be rewritten (e.g. by parsing HTML or scripts within the page for links, etc.).

The proxy device 502 can make a determination if a value 526 of a counter 524 of the device 502 (e.g., local counter maintained by the device) is less than a threshold 528. The threshold 528 indicative of a resource allocation limit. The resource allocation limit can be for the proxy device 502, a plurality of proxy devices 502 and/or a database server 520 synchronizing a counter 524 across a plurality of proxy devices 502. The proxy device 502 may compare a local counter value 526 for the server or tenant operating the server to a threshold 528 (or, in some implementations, the value of the local counter plus the number of links identified at step 606). If the counter value 526 has not exceeded the threshold 528—or if the counter 524 does not yet exist, such as for the first such request during a time period—then, at step 610 in some implementations, the proxy device 502 may rewrite or modify a link 547 in the page or resource 540 or chunk, as discussed above (e.g. replacing a link URL with a proxied URL 544 (e.g., modified link 544) and adding an entry to a local database associating the rewritten URL 544 or a hash value corresponding to the rewritten URL 544 with the corresponding original URL 542). The proxy device 502 can modify, responsive to the value 526 of the counter 524 being less than the threshold 528, one or more links 542 of the resource 540 (or web page, or chunk). The proxy device 502 can modify a link 542 to include a hash value that identifies an association between the respective modifying, by the device, the one or more links of the resource to include a hash value that identifies an association between the respective link 542 (e.g., original URL) and the corresponding generated modified link 544 and directs subsequent requests 530 from the client 504 via the modified link 544 to the proxy device 502. In embodiment, the proxy device 502 can process the resource 540 and associated links 542 in multiple portions or chunks having a determined size (e.g., 4 KB chunks) and including at least one link 542 of the one or more links 542. The proxy device 502 can process the resource 540 in in chunks or portions (such as 4 KB chunks), for example, to prevent the risk of a single malicious page having millions of links.

In other implementations, either before step 610, concurrently with step 610, or after step 610, at step 608 (shown in dashed line) the proxy device 502 may send a conditional create or “create if not exists” command 550 to a database server 520 identifying the link 542 (e.g. by hash value, index value, proxied URL, original URL, or other such identifier or combination of identifiers). The proxy device 502 can transmit, to the database server 520, a command 550 to generate an entry 560 at the database server 520 for the one or more links 542 of the resource 540 responsive to the value 526 of the counter 524 of the proxy device 502 being less than the threshold 538. The database server 520 may create a database entry 560 for the identified link 542 if one does not exist, and may respond with a callback in some implementations indicating that an entry 560 was created, or that an entry 560 was already existent (and not newly created). The proxy device 502 can modify the link 542 or multiple links 542 of the resource 440 responsive to the entry 560 existing at the database server 520 for the respective link 542 or respective multiple links 542 of the resource 540. In some implementations, to reduce communication requirements, the database server 520 may not provide a response if the entry 560 already exists in the database 520.

At step 614, the proxy device 502 may send an increment command 550 to the database server 520. The proxy device 502 can transmit, the database server 520, a command 550 to increment a value 526 of a counter 524 of the database server 520 for each link 542 of the one or more links 542 associated with the resource 540. In embodiments, the increment command 550 can include an instruction to increment or increase the value 526 of the counter 524, for example, by 1 for each link 542 of the one or more links 542 associated with the resource 540. The increment command 550 may comprise an identification of the server or tenant and, in some implementations, the time period (e.g. “tenantname_ddmm” or any similar format). If a counter 524 for the server or tenant and time period does not exist in memory of the database server 520 (e.g. if this is the first increment command of the time period received by the database server), then the database server 520 may create or instantiate a new counter 524 set to a value of 1. If the counter 524 exists, then the database server 520 may increment the value 526 of the counter 524. In embodiments, the proxy device 502 can transmit the increment command 550 in an asynchronous manner such that proxy device 502 may not wait for a response from the database server 520 to transmit the resource 540 to the client 504. The proxy device 502 can continue processing the links 542 of the resource 540 and transmit the resource 540 with the modified links 544 to the client 504 as the proxy device 502 works or communicates with the database server 520, for example, in parallel or at the same time.

In some implementations, prior to step 614, the proxy device 502 may determine at step 612 whether it has received a response 532 to a conditional create command 550 indicating that a database entry 560 was created or that a database entry 560 already existed. For example, the proxy device 502 can determine whether to provide modified one or more links 544 of the resource 540 to the client 504 based on a response 532 from the database server 520 indicating if the entry 560 is created for the one or more links 542 of the resource 540. If no response is received in some implementations, or if the proxy device 502 receives a response 532 indicating that the database entry 560 was already existent, then the proxy device 502 may skip step 614 in some implementations, as no additional memory resources are consumed by use of the already existent database entry 560. If the proxy device 502 receives a response 532 indicating that a new database entry 560 was created or, in some implementations, does not receive a response 532 indicating that the database entry 560 was already existent, then the proxy device 502 may transmit the increment command 550 at step 614. Steps 608-614, or in some implementations steps 610-614, may be repeated iteratively by the proxy device 502 for each additional identified link 542 in the page or resource 540 or chunk, asynchronously without waiting for a response 532 to any increment commands 550 from the database server 520. Once all links 542 have been rewritten in the page or resource 540 or chunk, the proxy device 502 may serve or stream the page or resource 540 or chunk to the requesting client device 504 at step 616. The proxy device 502 can provide the resource 540 including the modified one or more links 544 to the client 504. In embodiments, the proxy device 502 can provide or enable access to the resource 540 and the modified one or more links 544 through the multiple portions having the determined size to the client 504 (e.g., stream to the client). In embodiments, the proxy device 502 can provide to the client 504 the modified one or more links 544 of the resource 540 based on a response 532 from the database server 520 indicating that the entry 560 is created for the one or more links 542 of the resource 540 or based on a response 532 from the database server 520 indicating that the entry 560 already exists for the one or more links 542 of the resource 540. If additional chunks are present in the page or resource 540, in some implementations, steps 606-616 may be repeated for each additional chunk iteratively (shown in dashed line).

At step 618, the proxy device 502 may receive a callback or response 532 from the database server 520 with the value 526 of the database server 520 or tenant counter, incremented responsive to the increment command 50 or commands 550 sent by the proxy device 502. Although shown after step 616, in many implementations, step 618 may occur at any time in parallel with processing of the resource 540 (e.g., webpage or chunks). For example, a response 532 to a first increment command 550 may be received while the proxy device 502 is still processing other links 542 of the resource 540, on the page or within the chunk, or while processing a next chunk. In some implementations, increment commands 550 and/or responses 532 may be aggregated. For example, to reduce communications between the proxy device 502 and database server 520, in some implementations, several increment commands 550 may be aggregated during a given time period into a rate-limited (e.g. once per second, or any other such time period) multiple increment command 550, which may identify the server or tenant and time period as discussed above, as well as a number or value for the counter 524 to be incremented by. For example, rather than sending five increment commands 550 in series for five links 542 in a chunk, the proxy device 502 may rewrite all of the links 542 and generate the corresponding database entries 560, and send a single “tenant-name_ddmm&increment=5” increment command 550 (or similar structure) indicating to increment the corresponding counter 524 by five. Similarly, rather than responding to each increment command 550, in some implementations, the database server 520 may rate limit responses 532 and respond only to one increment command 550 for a given time period (e.g. one response per second), while still incrementing the counter 524 according to the received commands 550. Thus, upon receipt of five increment commands 550 within a second, the database server 520 may increment the counter 524 by five and respond with a single new value 526 of the counter 524. The response 532 may identify the server or tenant and time period, as with the command 550, in some implementations (e.g. “tenant-name_ddmm&value=5” or a similar structure). At step 620, the proxy device 502 may update (or store) the received counter value 526 (e.g., local counter 524 at respective device) in memory, including creating a new counter 524 or variable if one does not exist for the tenant or server (e.g. for the first request of the time period). The proxy device 502 can receive from the database server 520 a value 526 of the counter 524 (e.g., current value of the counter maintained at the database server) of the database server 520 indicating a number of resources 540 allocated by a plurality of devices 502 (e.g., aggregated total across each of the proxy devices 502 connected to the database server) connected to the database server 520 to the plurality of clients 504 and/or indicating a total number of modified links 544 generated by the database server 520 for the plurality of devices 502. The proxy device 502 can update the counter 524 of the device 502 (e.g., local counter maintained at the device) to synchronize to the value 526 of the counter 524 of the database server 520.

In normal operations, steps 604-620 may be repeated for additional proxied pages, clients, servers, and tenants, until the end of the time period, at which point step 602 may be repeated. However, if malicious or erroneous behavior or pages are processed by any proxy device 502, then the corresponding counter value 526 may be incremented beyond the threshold 528. In such instances, upon receipt of a request 530 for a resource 540 or page or chunk or interception of a response 532 at step 604, the proxy device 502 may determine that the corresponding counter value 526 exceeds the threshold 528. In response, in some implementations at step 626, the proxy device 502 may block or disable rewriting of links 542 or apply throttling (e.g. limiting the rate of rewriting links to one per second or any other such rate). The proxy device 502 can determine that the value 526 of the counter 524, for example, the local counter 524 of the respective device 502 or the counter 524 of the database server 520, is greater than the threshold 528 and prevent the client 504 from accessing the one or more resources 540 of the server 506 or links 542 associated with the one or more resources 540.

In embodiments, the proxy device 502 can process the links 542 (e.g., perform rewriting of the links 542) without waiting for a response from the database server 520 indicating the value 526 of the counter 524 or continue processing the links 542 until a response from the database server 520 indicating the value 526 of the counter 524 is received. For example, in some embodiments, the proxy device 502 can continue to rewrite links 542 of the resource 540 (e.g., links on the resource page) and continue to relay the one or more resources 540 including the modified links 544 to a client 504, for example, without introducing a delay (e.g., deteriorating client experience) as the proxy device 502 waits for a response from the database server 520 indicating the value 526 of the counter 524. The corresponding mapping in the database server 520 between the original version of the link 542 and the modified or rewritten version of the link 542 may not get created, in embodiments, until a response from the database server 520 is received indicating the value 526 or the counter 524 is less than the threshold 528. If a response is received from the database server 520 indicating the value 526 of the counter 524 is greater than the threshold 528, the mapping in the database server 520 between the original version of the link 542 and the modified or rewritten version of the link 542 is not created. In embodiments, when the client 504 attempts to access the modified or rewritten links 544 after the counter 524 had already exceeded the threshold 528, the proxy device 502 can prevent the access attempt such that the resource-access through the modified link 544 fails due to the missing mapping in the database server 520 between the original version of the link 542 and the modified or rewritten version of the link 542. At step 628, the proxy device 502 may, in some implementations, report an error or potentially malicious activity to a management service. The method may then return to step 604, and pages or chunks for other servers or tenants may be processed normally, thus avoiding the denial of service.

In some implementations, after the threshold 528 has been exceeded, before blocking or disabling rewriting of links 542 or applying throttling at step 626, the proxy device 502 may determine whether the link 542 being rewritten is a new link 542 or an already existing link 542 which would not cause any reduction in the proxy device's 502 capacity (e.g. not requiring a new database entry). The proxy device 502 can transmit to the database server 520, responsive to the value 526 of the counter 524 of the device 502 or the value 526 of the counter 524 maintained at the database server 520, being greater than the threshold 528, a command 550 to determine if an entry 560 exists at the database server 520 for at least one link 542 of the one or more links 542 of the resource 540. In embodiments, the proxy device 502 can prevent the client 504 access to the requested resource 540 responsive to determining that the database server 520 does not include an entry 560 for the link 542 or multiple links 542 of the resource 540 or based in part on a response 532 from the database server 520 indicating that an entry 560 was not created for the one or more links 542 of the resource 540.

In implementations, at step 622 (shown in dashed line), the proxy device 502 may transmit an expiration command including an identification of the link 542 (e.g. by hash value, key, proxied URL, original URL, or any combination of these or other identifiers) and a time-to-live (TTL) value to the database server 520 to extend the expiry-time of the corresponding database-entry by the TTL period, as described above. For example, the proxy device 502 can receive a request 530 to a resource 540 (e.g., new resource, subsequent resource) of the server 506. The resource 540 including at least one link 542. The proxy device 502 can determine that the value 526 of the counter 524 is greater than the threshold 528 and determine that the at least one link 542 of the resource 540 corresponds to a previously modified link 544 and an existing entry 560 at the database server 520. The proxy device 502 can transmit to the database server 520 a command 550 to extend an expiration value for the entry 560 at the database server 520 corresponding to the at least one link 542 or created for the at least one link 542. In some implementations, step 626 may be performed asynchronously and the proxy device 502 need not wait for a response 532 from the database server 520, but may proceed to step 610 for the current chunk (upon reaching the next chunk, the proxy device 502 can repeat from step 606; the response 532 to the expiration command 550 may be received at any time during this process). In some such implementations, the proxy device 502 may skip steps 608 and 614 for the rest of the chunk; that is, not transmitting conditional create commands 550 or increment commands 550 to the database server 520 for links 542 during this period (as the threshold 538 has already been exceeded).

Upon receipt of the expiration command 550, the database server 520 may set the corresponding database entry 560 (represented by the hash value or other identifier) to expire after the TTL period. This allows the database server 520 to extend the TTL period for existent database entries 560 that are re-utilized, ensuring that existent proxy services are not impacted due to blocking, throttling, or disabling of proxy services after the threshold 528 has been exceeded. However, if the database entry 560 does not exist, the database server 520 may have no entry 560 for which to refresh the TTL period, and in some implementations, may respond with an indication that the database entry 560 is new or does not exist. At step 624, if the proxy device 502 has received such an indication from the database server 520 (which may be received at any time during processing of the chunk or previous chunk during which the expiration command 550 was sent, as discussed above), the proxy device 502 may proceed to block or disable proxy services for the new page or resource 540 at step 626, as discussed above. The proxy device 502 can transmit to the database server 520, responsive to the value 526 of the counter 524 of the device 502 being greater than the threshold 528, a command 550 to determine if an entry 560 exists at the database server 520 for at least one link 542 of the one or more links 542 of the resource 540. The proxy device 502 can receive a response 532 indicating that an entry 560 for the at least one link 542 of the resource 540 does not exist at the database server 520 and the proxy device 502 can prevent access to the resource 540 for the client 504 responsive to determining the database server 520 does not include the entry 560 for the at least one link 542 of the resource 540. Accordingly, the threshold limit 528 can be approximately enforced (as the proxy device 502 may continue processing links 542 for a chunk that exceed the threshold 528, as discussed above), as no new database entry 560 would get created for the new resource 540 or page. Thus, after exceeding the threshold 528 for a server or tenant, the proxy device 502 may disable or block additional proxy services (which may be triggered due to a malicious or malformed page or resource) in an intelligent manner such that this disabling of proxy services impacts the new links 542 or database entries 560 and not existing links 542 or database entries 560.

As proxy devices 502 can operate independently, the local value 526 of a particular counter 524 may vary between devices 502. For example, a first proxy 502 may rewrite 100 links 542 for a particular tenant and the corresponding counter 524 may be incremented by the database server 520 and provided to the first proxy device 502, such that its local counter is 100. A second proxy device 502, having not yet rewritten any links 542 for the tenant and thus not provided any increment commands 550 and received any callbacks, may not have a local value 526 for the corresponding counter 524. Thus, the first proxy device 502 may have a counter value 526 of 100 and the second proxy device 502 may have no counter value 526 (or a value of 0 or null). Subsequently, if the second proxy device 502 receives a resource 540 (e.g., page) from the tenant and rewrites another 50 links 542, the second proxy device may receive an updated counter value 526 from the database server 520. Accordingly, the first proxy device 502 may have a counter value 526 of 100 and the second proxy device 502 may have a counter value 526 of 150. Thus, a local counter value 526 may be lower than the global counter value 526 maintained by the database server 520 due to race conditions. However, given that the threshold 528 may be significantly larger (e.g. orders of magnitude) greater than the number of links 542 that may exist within any particular chunk, this near-synchronization will not significantly affect identification and mitigation of denial of service conditions. For example, if the counter value 526 of the first proxy device 502 (and global counter value 526 maintained by the database server) hits a threshold 528 of 20000 links 542 for a tenant for the day, and the counter value 526 of the second proxy device 502 is only at 19995, the second proxy device 502 may process a subsequent resource 540, chunk or page for the tenant despite the tenant having exceeded the global threshold 528; however, as this resource 540, chunk or page may be limited in size (e.g. due to the proxy device 502 processing resources 540 in limited size chunks or portions) and thus have only a few links 542 (e.g. 10 links), the threshold 528 can be roughly enforced (e.g. the second proxy device 502 may process the additional ten links 542, receive a callback indicating the counter value 526 is now at 20005, and may cease further proxy services for the tenant). By allowing or enabling this looser synchronization and minor deviation beyond the threshold 528, communications between the proxy devices 502 and database server 520 may be significantly reduced (e.g. compared to pushing the counter value 526 to each proxy device 502 for each increment command) and latency of serving resources 540, pages or chunks to clients 504 may be reduced due to the avoided bandwidth and processing consumption.

In embodiments, if a threshold 528 is set too low, then normal proxying operations of a non-malicious tenant or server may cause a counter 524 to exceed the threshold 528. To avoid extended outages, in some implementations, after exceeding a threshold 528 and disabling or rate limiting further proxy servers 508, the proxy device 502 may periodically request the threshold value 528 for the server or tenant from the database server 520. If the threshold 528 has been increased (e.g. by an administrator or dynamically by the database server 520 in response to determining that the server is not malicious), then the proxy device 502 may reenable or resume normal proxying services in such implementations.

In some implementations, entries 560 in the proxy database may be periodically removed or pruned (or set to expire after a given time period, such as 7 days). This may avoid attacks from a malicious server where the number of links 542 are below the periodic threshold 528, but are still high in an attempt to exhaust storage capacity of the database. This may be done on a least recently used basis in some implementations, such that if a particular proxied link 544 is accessed within the pruning period (e.g. before a 7 day expiry window), the expiry time for that particular entry may be reset. Since malicious links are less likely to be accessed by client devices 504, corresponding database entries 560 will be automatically cleaned up, while legitimate entries will be maintained or refreshed with each new access.

FIG. 6B is a flow chart of database server operations, according to some implementations. At step 650, the database server 520 may receive an increment command 550 from a proxy device 502 identifying a server or tenant and time period and, in some implementations, an increment value. If a corresponding counter 524 does not exist for the server or tenant and time period, then at step 652, the counter 524 may be created or instantiated by the database server 520. At step 654, the counter 524 may be incremented (e.g. by one, or by an increment value in the increment command 550 in some implementations). At step 656, the resulting value 526 of the counter 524 may be provided to the proxy device 502 as a callback or response 532. Steps 650-656 may be repeated iteratively for additional increment commands from the proxy device or other proxy devices, until the expiration of a time period (e.g. end of the day). Upon expiration of the time period, at step 658, the counter 524 may be archived or logged or reset, and the process may repeat for the subsequent time period.

FIG. 6C is another flow chart of database server operations, according to some implementations. At step 670, the database server 520 may receive a conditional create command 550 or “create if not exists” command 550 including an identifier of a proxied link 544 (e.g. by hash value, index value, proxied or original URL, or any combination of these or other information). If the database entry 560 does not exist, the database server 520 may create a corresponding database entry 560 at step 672, and transmit an asynchronous callback (e.g., response 532) to the proxy device 502 indicating that the command 550 resulted in creation of a new database entry 560 at step 674. The database server 520 may subsequently receive an increment command 550 from the proxy device 502, as discussed above at step 650. If the database entry 560 already exists, then in some implementations, at step 676, the database server 520 may transmit an asynchronous callback (e.g., response 532) to the proxy device 502 indicating that the command 550 did not result in creation of a new database entry 560. This indicates that no new memory resources 540 were consumed by rewriting of the link 542. In some implementations, the database server 520 may refresh the existing database entry 560 (e.g. by extending a TTL value for the entry).

FIG. 6D is another flow chart of database server operations, according to some implementations. At step 690, the database server 520 may receive an expiration command 550 from the proxy device 502. The expiration command 550 may include an identification of a database entry 560 (e.g. by hash value, index value, proxied or original URL, or any combination of these or other information) and a TTL value in some implementations. If the database entry 560 exists, then at step 692, the database server 520 may refresh the TTL period for the database entry 560 (e.g. extending a TTL period for the entry 560 according to the TTL value in the expiration command 550, or according to a predetermined refresh duration in some implementations). At step 694, the database server 520 may asynchronously transmit a callback (e.g., response 532) to the proxy device 502 indicating that the database entry 560 already exists (and has been refreshed). If the database entry 560 does not exist, however, then at step 696 in some implementations, the database server 520 may transmit an asynchronous callback (e.g., response 532) to the proxy device 502 indicating that the database entry 560 does not exist and that no action was taken. In some implementations, step 696 (or alternately, step 694) may be skipped to reduce communications between the proxy device 502 and database server 520.

Accordingly, the systems and methods discussed herein provide for distributed HTTP proxy services with synchronization of per-server or per-tenant resource allocation counters 524 amongst the proxy devices 502, allowing devices 502 to quickly identify denial of service attacks or other malicious or erroneous behavior. In some implementations, a database server 520 may receive resource consumption notifications from each of a plurality of proxy devices 502 and may aggregate the notifications or increment a counter 524 on a per-server or per-tenant basis, and provide updated counter values 526 to proxy devices 502 via callbacks. Each proxy device 502 may check the counter value 526 before utilizing resources 540, and may disable or block proxy processing responsive to the counter 524 exceeding a threshold 528.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

What is claimed:

1. A method comprising:
receiving, by a device from a client, a request to access a resource of a server, the device deployed intermediary to a plurality of clients and a plurality of servers to proxy access to resources of the plurality of servers for the plurality of clients;
determining, by the device, if a value of a counter of the device is less than a threshold, the threshold indicative of a resource allocation limit;
modifying, by the device responsive to the value of the counter of the device being less than the threshold, one or more links of the resource; and
providing, by the device, the resource including the modified one or more links to the client.

2. The method of claim 1, comprising:
processing, by the device, the resource in multiple portions, each portion having a determined size and including at least one link of the one or more links;
providing, by the device to the client device, access to the resource and the modified one or more links through the multiple portions having the determined size.

3. The method of claim 1, comprising:
transmitting, by the device to a database server, a command to generate an entry at the database server for the one or more links of the resource responsive to the value of the counter of the device being less than the threshold.

4. The method of claim 1, comprising:
modifying, by the device, the one or more links of the resource to include a hash value that identifies an association between the respective link and the corresponding modified link and directs subsequent requests from the client via the modified link to the device.

5. The method of claim 1, comprising:
transmitting, by the device to a database server, a command to increment a value of a counter of the database server for each link of the one or more links associated with the resource.

6. The method of claim 1, comprising:
receiving, by the device from a database server, a value of a counter of the database server indicating a number of resources allocated by a plurality of devices connected to the database server to the plurality of clients; and
updating, by the device, the counter of the device to synchronize to the value of the counter of the database server.

7. The method of claim 1, comprising:
receiving, by the device from the client, a request to access one or more resources of the server;
determining, by the device, that the value of the counter of the device is greater than the threshold; and
preventing, by the device, the client from accessing the one or more resources of the server.

8. The method of claim 1, comprising:
transmitting, by the device to a database server responsive to the value of the counter of the device being greater than the threshold, a command to determine if an entry exists at the database server for at least one link of the one or more links of the resource; and
modifying, by the device, the at least one link responsive to the entry existing at the database server for the at least one link of the resource.

9. The method of claim 1, comprising:
transmitting, by the device to a database server responsive to the value of the counter of the device being greater than the threshold, a command to determine if an entry exists at the database server for at least one link of the one or more links of the resource; and
preventing, by the device, access to the resource for the client responsive to determining the database server does not include the entry for the at least one link of the resource.

10. The method of claim 1, comprising;
receiving, by the device from the client, a request to access a subsequent resource of the server, the subsequent resource including at least one link;
determining, by the device, that the value of the counter of the device is greater than the threshold;
determining, by the device, that the at least one link of the subsequent resource corresponds to previously modified link; and
transmitting, by the device to a database server, a command to extend an expiration value for an entry at the database server corresponding to the at least one link.

11. A method comprising:
receiving, by a device from a client, a request to access a resource of a server, the device deployed intermediary to a plurality of clients and a plurality of servers to proxy access to resources of the plurality of servers for the plurality of clients;
transmitting, by the device to a database server, a command to create an entry in a database of the database server for the one or more links of the resource;
modifying, by the device, one or more links of the resource; and
determining, by the device, whether to provide the modified one or more links of the resource to the client based on a response from the database server indicating if the entry is created for the one or more links of the resource.

12. The method of claim 11, comprising:
providing, by the device to the client, the modified one or more links of the resource based on the response from the database server indicating that the entry is created for the one or more links of the resource.

13. The method of claim 12, comprising:
transmitting, by the device to a database server, a command to increment a value of a counter of the database server for each link of the one or more links associated with the resource.

14. The method of claim 11, comprising:
preventing, by the device, the client from accessing the resource based on the response from the database server indicating that the entry is not created for the one or more links of the resource.

15. The method of claim 11, comprising:
determining, by the device, that a value of a counter of the device is less than a threshold, the threshold indicative of a resource allocation limit for the device; and
providing, by the device, the resource including the modified links to the client.

16. The method of claim 11, comprising:
determining, by the device, that a value of a counter of the device is greater than a threshold, the threshold indicative of a resource allocation limit for the device; and
determining, by the device, that the one or more links of the resource correspond to previously modified links; and
transmitting, by the device to a database server, a command to extend an expiration value for entries at the database server corresponding to the one or more links.

17. The method of claim 11, comprising:
determining, by the device, that a value of a counter of the device is greater than a threshold, the threshold indicative of a resource allocation limit for the device; and
determining, by the device, that the one or more links of the resource correspond to new requests; and
preventing, by the device, access to the resource for the client.

18. A device comprising:
one or more processors coupled to memory, the device configured to:
receive, from a client, a request to access a resource of a server, the device deployed intermediary to a plurality of clients and a plurality of servers to proxy access to resources of the plurality of servers for the plurality of clients,
determine if a value of a counter of the device is less than a threshold, the threshold indicative of a resource allocation limit;
modify, responsive to the value of the counter of the device being less than the threshold, one or more links of the resource; and
provide the resource including the modified one or more links to the client.

19. The device of claim 18, wherein the device is configured to:
receive, from a database server, a value of a counter of the database server indicating a number of resources allocated by a plurality of devices connected to the database server; and
update the counter of the device to synchronize to the value of the counter of the database server.

20. The device of claim 18, wherein the device is configured to:
transmit, to a database server responsive to the value of the counter of the device is greater than the threshold, a command to determine if an entry exists at the database server for at least one link of the one or more links of the resource; and
modify the at least one link responsive to the entry existing at the database server for the at least one link of the resource.
